(19) United States
(12) Patent Application Publication
(10) Pub. No.: US 2012/0327972 A1
(43) Pub. Date: Dec. 27, 2012

(54) TEMPERATURE SENSOR

(75) Inventor: Jong SEON, Suwon-si (KR)

(73) Assignee: LSIS CO., LTD., Anyang-si (KR)

(21) Appl. No.: 13/533,912

(22) Filed: Jun. 26, 2012

(30) Foreign Application Priority Data
Jun. 27, 2011 (KR) 10-2011-0062552

(51) Int. Cl. G01K 7/01

(52) U.S. Cl. 374/178; 374/E07.035

(57) ABSTRACT

Provided is a low power consuming, highly precise, wide-range temperature sensor. The temperature sensor includes a current mirror, a first MOS transistor, and a second MOS transistor. The current mirror generates a first reference current in response to a particular current applied by a power voltage and a second reference current in response to the first reference current so as to output the first and second reference currents. The first MOS transistor includes a drain terminal D1 receiving the first reference current and a gate terminal G1 receiving a bias voltage. The second MOS transistor includes a drain terminal D2 receiving the second reference current, and the second MOS transistor generates an output voltage.

### CROSS-REFERENCE TO RELATED APPLICATIONS

Pursuant to 35 U.S.C. §119(a), this application claims the benefit of earlier filing date and right of priority to Korean Patent Application No. 10-2011-0062552, filed on Jun. 27, 2011, the contents of which are hereby incorporated by reference herein in its entirety.

### BACKGROUND

The present disclosure relates to a low power consuming, highly precise, wide-range temperature sensor, and more particularly, to a temperature sensor using complementary metal oxide semiconductor (CMOS) transistors instead of parasitic PNP transistors so as to measure temperatures in a wider linear region while consuming low power.

Much research has been conducted to reduce power consumption along with the increasing demand on reduction of power consumption. For example, in an attempt to reduce power consumption, internal operations are varied according to chip operation temperatures to control power consumption. That is, it is detected whether temperature is higher or lower than a certain value, and operations of a chip are varied according to the detection result. For this, a temperature sensor is necessary to measure temperature variations in the chip.

In the case of temperature sensors of the related art, only an output of several micro volts (μV) can be obtained with respect to a temperature variation of 1° C. although a current ratio between transistors is increased, and thus a very precise circuit is necessary to detect such a low output voltage and temperature detection precision is not good.

In addition, linear regions of related-art temperature sensors that can be used for temperature detection are limited. That is, related-art temperature sensors are non-linear at high temperatures and lower temperatures. Thus, generally, temperature sensors of the related art are used for measuring temperatures only at a limited temperature range.

### SUMMARY

Embodiments provide a temperature sensor using complementary metal oxide semiconductor (CMOS) transistors instead of parasitic PNP transistors, so as to minimize the size thereof in a chip, increase a linear region thereof that can be used for temperature detection, and reduce power consumption thereof.

In one embodiment, a temperature sensor includes: a current mirror generating a first reference current in response to a particular current applied by a power voltage and a second reference current in response to the first reference current, so as to output the first and second reference currents; a first MOS transistor including a drain terminal receiving the first reference current and a gate terminal receiving a bias voltage; and a second MOS transistor including a drain terminal receiving the second reference current, the second MOS transistor generating an output voltage.

The details of one or more embodiments are set forth in the accompanying drawings and the description below. Other features will be apparent from the description and drawings, and from the claims.

### BRIEF DESCRIPTION OF THE DRAWINGS

FIG. 1 is a basic circuit diagram illustrating a low power consuming, highly precise, wide-range temperature sensor according to an embodiment.

FIG. 2 is a detailed circuit diagram of the temperature sensor according to an embodiment.

FIGS. 3 and 4 are views illustrating the temperature sensor with an additional amplifier according to an embodiment.

### DETAILED DESCRIPTION OF THE EMBODIMENTS

Hereinafter, a low power consuming, highly precise, and wide-range temperature sensor will be described in detail with reference to the accompanying drawings, in which exemplary embodiments are illustrated.

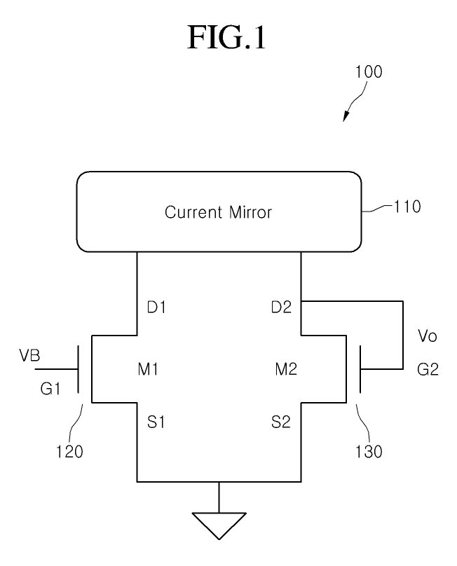

FIG. 1 is a basic circuit diagram illustrating a low power consuming, highly precise, wide-range temperature sensor 100 according to an embodiment.

The temperature sensor 100 of the embodiment includes a current mirror 110, a first MOS transistor 120, and a second MOS transistor 130.

The current mirror 110 may include bipolar transistors or MOS transistors.

If the current mirror 110 includes MOS transistors, the current mirror 110 may include a third MOS transistor and a fourth MOS transistor. The third and fourth MOS transistors may be p-MOS or n-MOS transistors. The third and fourth MOS transistors may be MOS transistors of the same kind.

The current mirror 110 may generate a first reference current in response to a particular current applied by power voltage and may generate a second reference current in response to the first reference current. That is, the current mirror 110 may generate first and second reference currents.

If the third and fourth MOS transistors have the same characteristics, in other words, if the third and fourth transistors have the same transistor characteristics determined by widths, lengths, etc, the second reference current is equal to the first reference current.

The first MOS transistor 120 and the second MOS transistor 130 may be p-MOS or n-MOS transistors.

In the following description, the width (crosswise) of a MOS transistor is denoted by “W” and the length (height) of the transistor is denoted by “L.” K1=W1/L1 is a ratio of the width W1/length L1 of the first MOS transistor 120, and K2=W2/L2 is a ratio of the width W2/length L2 of the second MOS transistor 130.

The ratio (K1=W1/L1) of the width W1/length L1 of the first MOS transistor 120 may be N times the ratio (K2=W2/L2) of the width W2/length L2 of the second MOS transistor 130. Therefore, K1 may be N*(W2/L2) where N denotes a rational number.

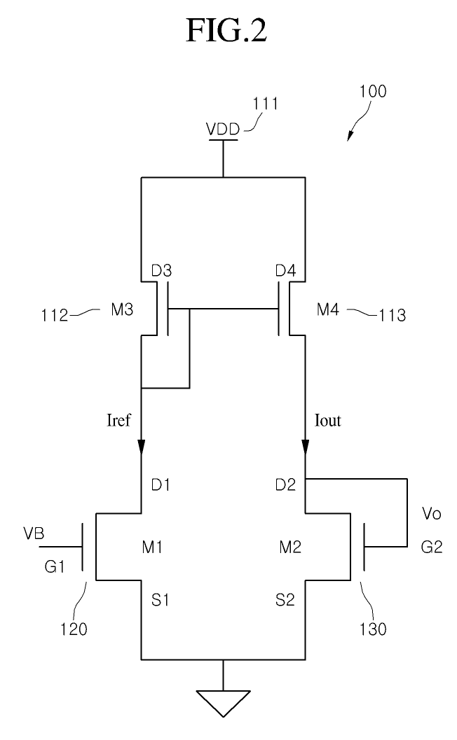

FIG. 2 is a detailed circuit diagram of the temperature sensor 100 according to an embodiment.

In the embodiment shown in FIG. 2, the current mirror 110 is composed of MOS transistors.

The current mirror 110 may include third and fourth MOS transistors 112 and 113 which are p-MOS transistors.

A power voltage 111 may be connected to a drain terminal D3 of the third MOS transistor 112 and a drain terminal D4 of the fourth MOS transistor 113.

The current mirror 110 generates a first reference current Iref in response to a particular current applied by the power voltage 111, and outputs the first reference current Iref and a second reference current lout.

The first reference current Iref is applied to a drain terminal D1 of the first MOS transistor 120, and the second reference current lout is applied to a drain terminal D2 of the second MOS transistor 130.

If the first and second reference currents Iref and lout are applied from the current mirror 110 to the first MOS transistor 120 and the second MOS transistor 130, an output voltage V_{O} may be obtained between a gate terminal G2 and the drain terminal D2 of the second MOS transistor 130.

The output voltage Vₒ can be simply expressed by Equation 1 below.

$${V}_{o} = \sqrt{\frac{{K}_{1}}{{K}_{2}}} {V}_{B} + ( 1 - \sqrt{\frac{{K}_{1}}{{K}_{2}}} ) {V}_{T} \qquad [ Equation 1 ]$$

In Equation 1, V_{B} denotes a bias voltage. The bias voltage means a voltage applied to, for example, a signal electrode for determining an operation reference point of a transistor. The bias voltage V_{B} may be a self bias voltage applied by using an operating current of a circuit.

The bias voltage V_{B} may be applied to a gate terminal G1 of the first MOS transistor 120.

In Equation 1, V_{T} denotes a threshold voltage. Threshold voltage means a minimal voltage at which a semiconductor device or a circuit starts to operate.

The threshold voltage V_{T} may be expressed using a CMOS model equation as Equation 2.

V_{T}=V_{T}_{ᵣ}−α(T−Tᵣ) Equation 2

In Equation 2, T denotes a temperature, Tr denotes room temperature, a denotes a process variable, and V_{Tr} denotes a threshold voltage at room temperature.

Therefore, the output voltage Vₒ may be expressed as Equation 3.

$${V}_{o} = \sqrt{\frac{{K}_{1}}{{K}_{2}}} \cdot {V}_{B} - ( 1 - \sqrt{\frac{{K}_{1}}{{K}_{2}}} ) \cdot ( {V}_{Tr} - α ( T - {T}_{r} ) ) \qquad [ Equation 3 ]$$

The output voltage V_{O} varies according to temperature (T), and thus the circuit shown in FIG. 2 can be used for measuring temperatures.

The output voltage V_{O} may be changed by varying the ratio (K1=W1/L1) of the width W1/length L1 of the first MOS transistor 120 and the ratio (K2=W2/L2) of the width W2/length L2 of the second MOS transistor 130.

In addition, the output voltage V_{O} may be changed by varying the bias voltage V_{B.}

Therefore, temperatures can be measured in a wide range by adjusting a temperature rate by varying a ratio of K1/K2 of the first MOS transistor 120 and the second MOS transistor 130 or the bias voltage V_{B}.

Specifically, in the case of a related-art temperature sensor using a parasitic PNP transistor, a linear region that can be used for temperature measurement is limited to a particular range, for example, a range of −20° C. to 50° C., and high-temperature and low-temperature regions are nonlinear.

Moreover, parasitic PNP transistors are large, and the area for a chip increases largely as a current flowing in a PNP transistor is increased.

However, the temperature sensor 100 of the embodiment has linearity in a wider temperature range, for example, from −30° C. to 100° C. as compared with a related-art temperature sensor, and thus temperatures can be measured in a wider range. In addition, since the temperature sensor 100 uses CMOS transistors, the size of the temperature sensor 100 can be reduced.

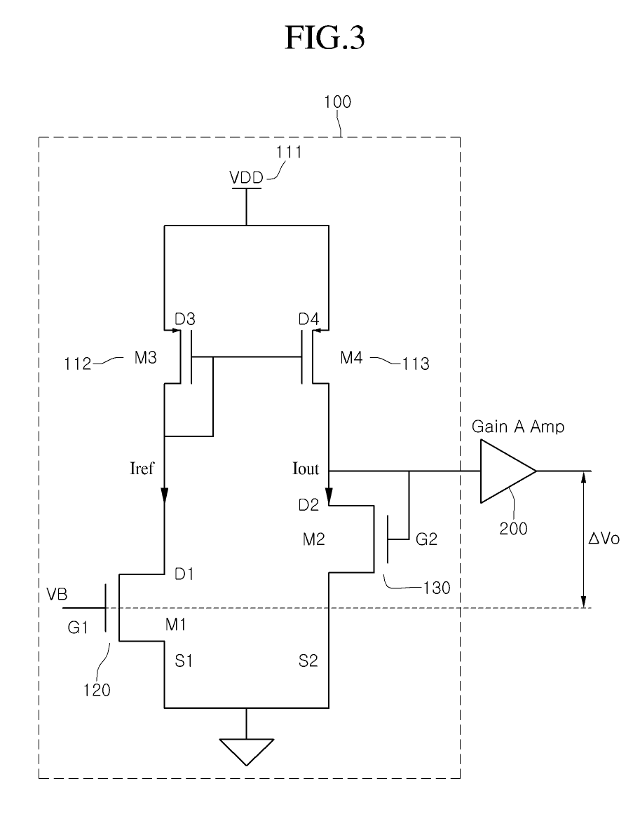

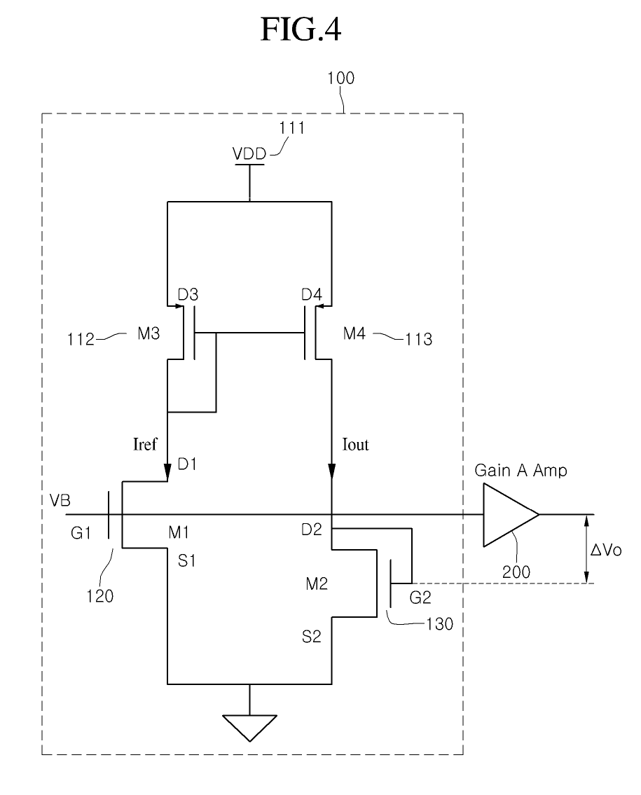

FIGS. 3 and 4 are views illustrating the temperature sensor 100 with an additional amplifier according to an embodiment.

As shown in FIGS. 3 and 4, an amplifier 200 having gain (A) may be added to the circuit shown in FIG. 2. In the current embodiment, the gain of the amplifier 200 may be denoted by (A), and A may be a rational number.

The amplifier 200 may be a differential amplifier that can be used for calculation.

The amplifier 200 may be used for directly detecting the threshold voltage V_{T} expressed by Equation 2. That is, the amount of variation of output voltage ΔV_{O} can be calculated using Equation 3, and the amount of variation of output voltage ΔV_{O} is equal to the threshold voltage V_{T}(ΔV_{O}=V_{T}).

Accordingly, the amount of variation of output voltage ΔV_{O} can be calculated using Equation 4.

ΔVₒ=Vᵣ=V_{Tr}α(T−Tᵣ) [Equation 4]

As shown in Equation 4, temperature (T) can be directly calculated by measuring the amount of variation of output voltage ΔV_{O}.

In the circuit diagram shown in FIG. 3, the ratio (K1=W1/L1) of the width W1/length L1 of the first MOS transistor 120 is smaller than the ratio (K2=W2/L2) of the width W2/length L2 of the second MOS transistor 130 (K1 <K2, N<1).

In this case, according to Equation 3, the output voltage V_{O} increases as temperature (T) increases.

In the circuit diagram shown in FIG. 4, the ratio (K1=W1/L1) of the width W1/length L1 of the first MOS transistor 120 is greater than the ratio (K2=W2/L2) of the width W2/length L2 of the second MOS transistor 130 (K1>K2, N>1).

In this case, according to Equation 3, the output voltage V_{O} decreases as temperature (T) decreases.

Therefore, as illustrated with reference to the circuit diagrams of FIGS. 3 and 4, the output voltage V_{O} can be varied with a positive or negative rate according to variation of temperature (T) by adjusting the ratio (K1/K2) of the first MOS transistor 120 and the second MOS transistor 130.

The low power consuming, highly precise, wide-range temperature sensor according to the embodiments provides the following effects.

First, the size of the temperature sensor in a chip can be minimized because the temperature sensor uses CMOS transistors instead of parasitic PNP transistors that are used in temperature sensors of the related art.

Secondly, the temperature sensor according to the embodiments has linearity in a wider temperature range as compared with temperature sensors of the related art. For example, the temperature sensor of the embodiments may have linearity in the temperature range from −30° C. to 100° C. In addition, the temperature sensor of the embodiments has a higher temperature variation coefficient for a temperature variation of 1° C., the temperature sensor of the embodiments can be used in various fields.

Thirdly, the temperature sensor of the embodiments may be suitable for low power consumption designs because the temperature sensor does not require a precise circuit for detecting a low voltage.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A temperature sensor comprising:
a current mirror generating a first reference current in response to a particular current applied by a power voltage and a second reference current in response to the first reference current, so as to output the first and second reference currents;
a first MOS transistor comprising a drain terminal receiving the first reference current and a gate terminal receiving a bias voltage; and
a second MOS transistor comprising a drain terminal receiving the second reference current, the second MOS transistor generating an output voltage.

2. The temperature sensor according to claim 1, further comprising an amplifier to amplify the output voltage.

3. The temperature sensor according to claim 2, wherein the amplifier has gain of A where A denotes a rational number.

4. The temperature sensor according to claim 1, wherein each of the first and second MOS transistors is one of a p-MOS transistor and an n-MOS transistor.

5. The temperature sensor according to claim 1, wherein when the first MOS transistor has a width W1, a length L1, and a ratio K1 of W1/L1 and the second MOS transistor has a width W2, a length L2, and a ratio K2 of W2/L2, the output voltage is changed by varying a ratio of K1/K2 of the first and second MOS transistors.

6. The temperature sensor according to claim 1, wherein the output voltage is changed by the bias voltage applied to the gate terminal of the first MOS transistor.

7. The temperature sensor according to claim 5, wherein the ratio of K1/K2 of the first and second MOS transistors satisfies that K1=W1/L1 is N times K2=W2/L1 where N denotes a rational number.

8. The temperature sensor according to claim 1, wherein the current mirror comprises a third MOS transistor and a fourth MOS transistor, and each of the third and fourth MOS transistors is one of a p-MOS transistor and an n-MOS transistor,
wherein the third and fourth MOS transistors are transistors of the same kind.

9. The temperature sensor according to claim 1, wherein the current mirror comprises a first bipolar transistor and a second bipolar transistor.
